(19) United States
(12) Patent Application Publication
(10) Pub. No.: US 2025/0162799 A1
(43) Pub. Date: May 22, 2025

(54) PILLAR FOR GRID-BASED STORAGE SYSTEM HAVING CONSTRAINING FEATURES

(71) Applicant: Nimble Robotics, Inc., San Francisco, CA (US)

(72) Inventor: Simon Kalouche, San Francisco, CA (US)

(73) Assignee: Nimble Robotics, Inc., San Francisco, CA (US)

(21) Appl. No.: 18/853,857

(22) PCT Filed: Apr. 5, 2023
(86) PCT No.: PCT/US2023/017507

§ 371 Date: Oct. 3, 2024

Related U.S. Application Data
(60) Provisional application No. 63/327,923, filed on Apr. 6, 2022.

(51) Int. Cl. B65G 1/04

(52) U.S. Cl. CPC B65G 1/0464; B65G 1/0457

(57) ABSTRACT

A pillar for supporting a grid formed of a first set of a parallel rails extending in an x-direction and a second set of parallel rails extending in a y-direction. The pillar extending along an axis in a z-direction and including a constraining feature arranged to prevent a grapple from moving away from the axis in the x-direction and in the y-direction as the grapple is lowered in the z-direction to secure a container. A grid-based storage structure formed of pillars including the constraining feature can thus be assembled using less pillars than a storage structure formed of conventional pillars and, therefore, can also be constructed with significantly lower costs.

### CROSS-REFERENCE TO RELATED APPLICATIONS

This application claims the benefit of the filing date of U.S. Provisional Patent Application No. 63/327,923 filed Apr. 6, 2022, the disclosure of which is hereby incorporated herein by reference.

### BACKGROUND OF THE INVENTION

The present disclosure relates generally to robotic storage and retrieval systems, and more particularly, to grid-based storage frames.

Warehouses, or distribution fulfillment centers, require systems that enable the efficient storage and retrieval of a large number of diverse products. Traditionally, inventory items are stored in containers and arranged on rows of shelving on either side of an aisle. Each container holds a plurality of items of one or more product types. The aisles provide access between the shelving for an operator or robot to migrate the aisles and retrieve the items. It is well understood that the aisles reduce the storage density of the system. In other words, the amount of space used for the storage of products (e.g., the shelving) is relatively small compared to the amount of space required for the storage system as a whole. As warehouse space is often scarce and expensive, alternative storage systems that maximize storage space are desired.

In one alternative approach, which offers a significant improvement in storage density, containers are stacked on top of one another and arranged in adjacent rows. That is, no aisle is provided between the adjacent rows of stacked containers. In turn, more inventory can be stored in a given space.

Various methods for retrieving inventory from the stacked containers have been contemplated. U.S. Pat. Pub. No. 2021/0032034, for example, discloses a system in which containers are arranged in a plurality of stacks underneath a grid. Robots equipped with a picking arm and/or a lifting apparatus navigate the grid, extract containers when necessary, and then pick and pack the items into order containers.

Despite the improved storage density offered by the stacked storage system, the system is not without shortcomings. For example, the grid-based storage frame is expensive to manufacture because of the amount of metal required to construct the frame and the rising cost of that metal.

### BRIEF SUMMARY

In accordance with a first aspect of the present disclosure, a pillar for a grid-based storage frame is provided. Among other advantages, the pillar includes constraining features designed to constrain the lifting apparatus of a robot to that pillar, thereby aligning the grapple of the lifting apparatus to a stack of containers as the grapple is extended and retracted in the z-direction. Consequently, a grid-based storage frame constructed with pillars including the constraining features can be manufactured using fewer pillars than a grid-based storage frame constructed using conventional pillars and, as a result, is significantly less expensive to manufacture.

In one aspect, a pillar having a central axis extending in a z-direction for supporting a grid formed of a first set of a parallel rails extending in an x-direction and a second set of parallel rails extending in a y-direction, is provided. The pillar includes at least one constraining feature arranged to prevent a grapple configured to extract a container located beneath the grid from moving relative to the pillar in the x-direction and in the y-direction as the grapple is lowered in the z-direction; and/or
the pillar may include a body and the at least one constraining feature may be provided at a corner section of the body; and/or
the at least one constraining feature may include a plurality of constraining features, and each one of the plurality of constraining features may be provided at a respective corner section of the body.

In another aspect, a storage and retrieval system includes: a storage structure having pillars extending in a z-direction, the pillars supporting a grid formed of a first set of a parallel rails extending in an x-direction and a second set of parallel rails extending in a y-direction, the grid defining a plurality of grid spaces; and a plurality of containers being stackable upon one another to form a plurality of vertical stacks, each vertical stack being arranged within a footprint of a respective one of the plurality of grid spaces, wherein each pillar includes at least one constraining feature arranged to prevent a grapple configured to extract a container located beneath the grid from moving relative to the pillar in the x-direction and in the y-direction as the grapple is lowered in the z-direction; and/or
the pillars may be formed of a metal or metal alloy; and/or
each grid space may be supported by a maximum of three pillars; and/or
each grid space may be supported by a maximum of two pillars; and/or
each grid space may be supported by a single pillar; and/or
the at least one constraining feature may be located at a corner section of a respective one of the pillars; and/or
the at least one constraining feature may include a plurality of constraining features and each one of the plurality of constraining features may be provided within a respective one of the corner sections; and/or
each one of the pillars may include a body having a central section, first and second pairs of parallel ribs may extend from opposite sides of the central section in the x-direction and third and fourth pairs of parallel ribs may extend from opposite sides of the central section in the y-direction such that the pairs of parallel ribs define four corner sections, and each one of the four corner sections may include one or more of the at least one constraining features; and/or
one of the constraining features may include a first protrusion extending away from the first and second pairs of parallel ribs in the y-direction and into a respective one of the four corner sections; and/or
each one of the constraining features may include a second rib protruding away from the third and fourth pairs of parallel ribs in the x-direction and into a respective one of the four corner sections; and/or
the at least one constraining feature may have a cross-section shaped approximately as a “T”; and/or
each corner section of a respective one of the pillars may includes two of the “T” shaped constraining features; and/or
the at least one constraining feature may have a circular or oval cross-section; and/or
the system may further include at least one robot installed on the grid, the robot having:
   a body coupled to a wheel assembly, the wheel assembly including a plurality of wheels and a drive mechanism arranged to move the body along the first set of parallel rails and along the second set of parallel rails; and at least one grapple extendable in the z-direction and arranged to selectively secure and lift one or more containers from a stack of containers, the grapple including at least one carriage provided at a corner of the grapple to engage the constraining feature of the pillar and to prevent the grapple from moving relative to the pillar in the x-direction and in the y-direction as the grapple is lowered in the z-direction; and/or
the at least one carriage may include roller bearings; and/or
the at least one carriage may include a first carriage protruding from the corner of the grapple in the x-direction and a second carriage may protrude from the corner of the grapple in the y-direction; and/or
the at least one carriage may include roller bearings on either side of a recess sized and configured to receive the at least one constraining feature.

### BRIEF DESCRIPTION OF THE DRAWINGS

FIG. 1 is a schematic perspective view of a grid-based storage frame for housing a plurality of stacked containers according to the prior art.

FIG. 2A is a top elevation view of a grid pillar according to the prior art.

FIG. 2B is a top elevation view of a known grapple being lowered within a portion of a grid-based storage frame constructed with the pillars of FIG. 2A.

FIG. 3A is a perspective view of a robot equipped with a grapple according to an embodiment of the present disclosure.

FIG. 3B is a perspective view of a portion of the grapple of FIG. 3A.

FIG. 4A is a schematic top elevation view of a grid pillar having constraining features according to a first embodiment of the present disclosure.

FIG. 4B is a schematic top elevation view of the grapple of FIG. 3A being constrained to the grid pillar of FIG. 4A.

FIG. 4C is a perspective view illustrating a carriage of the grapple of FIG. 3B moving along a linear track defined by the constraining feature of FIG. 4A.

FIG. 5A is a schematic top elevation view of a variant grapple being constrained to a grid pillar according to a second embodiment of the present disclosure.

FIG. 5B is a perspective view of yet another variant grapple being constrained to a constraining feature of a grid pillar according to a third embodiment of the present disclosure.

FIG. 6 is a schematic top elevation view of a portion of a grid-based storage frame constructed using the grid pillars of FIG. 4A.

### DETAILED DESCRIPTION

As used herein, when terms of orientation, for example, “vertical” and “horizontal” or relative terms such as, “above,” “upwards,” “beneath,” “downwards” and the like are used to describe the orientation or relative position of specific features of the storage frame or mobile robot, the terms are in reference to the orientation or the relative position of the features in the normal gravitational frame of reference when the storage frame is positioned with a bottom of the storage frame resting on a surface. Similarly, the term “z-direction” refers to the vertical direction, while the term “x-direction” refers to a first horizontal direction and the term “y-direction” refers to a second horizontal direction perpendicular to the x-direction. Also as used herein, the terms “substantially,” “generally,” “about” and the like are intended to mean that slight deviations from absolute are included within the scope of the term so modified.

FIG. 1 illustrates a storage structure for storing a plurality of stackable containers 10 according to the prior art. Each container 10 typically holds a plurality of product items (not shown) of identical or different product types. Containers 10 are designed to nest against an upper surface (i.e., rim) of another container to form stacks 12 that can be arranged in a frame 14.

Frame 14 includes pillars 16 that support a series of rails 22 arranged in a grid-like pattern at an uppermost level of the frame. For this reason, rails 22 are collectively referred to as a grid 26 and define a plurality of “grid spaces.” Pillars 16 form shafts for housing stacks 12. As a result, each stack 12 is located within the footprint of a respective grid space (e.g., longitudinally underneath the respective grid space).

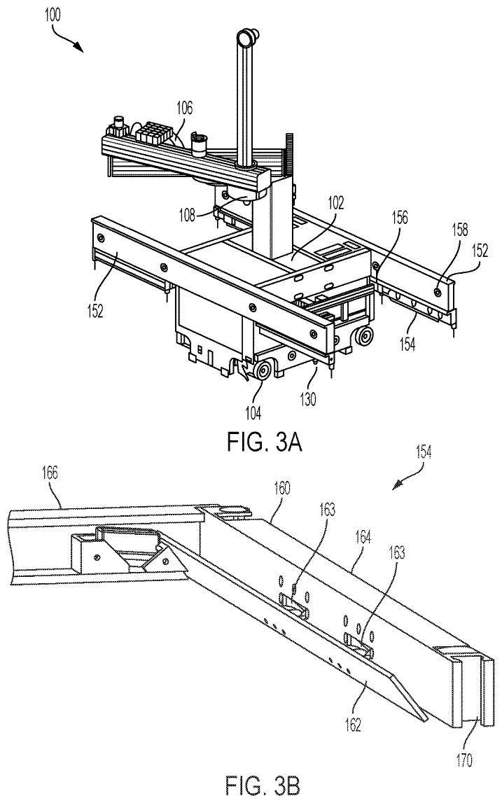

Each rail 22 has a profiled track that provides a drive surface for robots 100 (FIG. 3A) to move about grid 26 while picking and packing orders. A first set of parallel rails 22a guides movement of robots 100 in a first direction (e.g., the x-direction), and a second set of parallel rails 22b, arranged perpendicular to the first set of parallel rails, guides movement of the robots in a second direction (e.g., the y-direction). In this manner, rails 22 allow robot 100 to move laterally in two directions (in the x-direction and in the y-direction) across the top of frame 14 such that the robots can be moved into position above any one of the stacks 12 of containers 10.

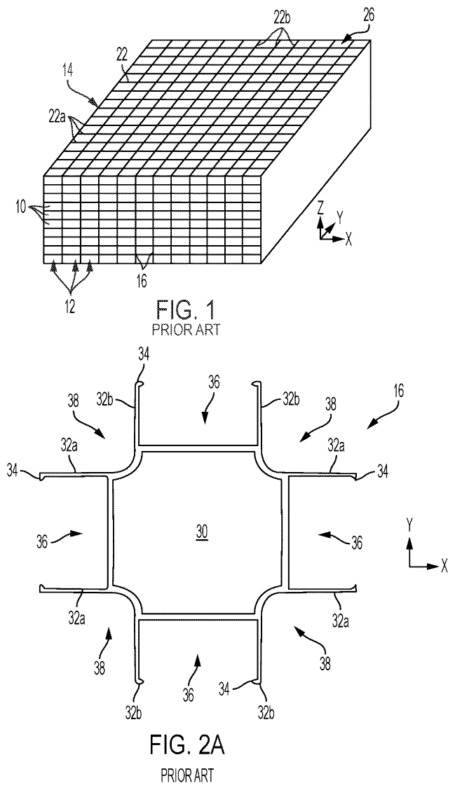

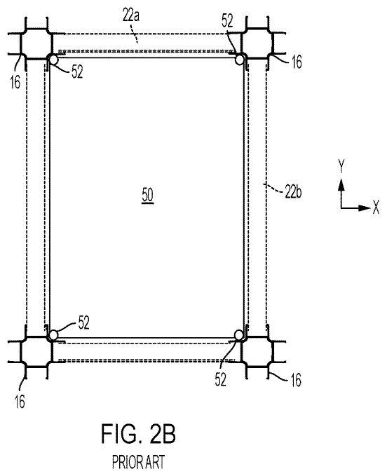

FIG. 2A is a top elevation view illustrating pillar 16 in greater detail. Pillar 16 may be formed by extruding a metal, such as aluminum, or a metal alloy, such as steel, in the z-direction. The body of pillar 16 has a cross-section shaped generally as a “number sign” (#) that includes a quadrilateral center section 30 and four pairs of parallel ribs extending away from a central axis of the center section in a cross-like arrangement. That is, a first pair of parallel ribs 32a and a second pair of parallel ribs 32a extend from opposite sides of central section 30 in the x-direction, and a third pair of parallel ribs 32b and a fourth pair of parallel ribs 32b project from opposite sides of central section 30 in the y-direction. The first and second pair of parallel ribs 32a are thus arranged to secure rails 22a, while the third and fourth pair of parallel ribs 32b are arranged to secure rails 22b (FIG. 2B).

As shown in FIG. 2A, each rib 32a and each rib 32b includes a clip 34 that protrudes into a respective side section 36 of pillar 16 to assist in securing rails 22a and rails 22b to the pillar. As used herein, the term “side section” refers to an area of the body located outside of central section 30 and on a lateral side of the central section (e.g., the locations at which rails 22 are attached). When the body of pillar 16 is shaped generally as a “number sign,” side section 36 refers to the area located between two ribs of a single pair of parallel ribs. The area of the body located at the corners of central section 30 (e.g., adjacent the junction of rail 22a and rail 22b) is referred to herein as a corner section 38. In examples in which the body of pillar 16 has a cross-section shaped approximately as a “number sign,” corner section 38 is located between one rib of ribs 32a and one rib of ribs 32b. As used herein, the terms “side sections” and “corner sections” refer to the orientation of the pillar relative to the intended attachment of rails 22. Put differently, the “side sections” and “corner sections” should not be interpretated to require that the body of pillar 16, or other pillars discussed herein, include parallel sets of ribs that form a “number sign” shaped cross-section. Instead, such additional description is provided merely to describe the “side sections” and “corner sections” in view of known pillar 16.

FIG. 2B is a top elevation view illustrating the grapple 50 of a known lifting device descending into a shaft defined by four pillars 16. The corner of each corner section 38 (e.g., the junction of central section 30 and corner section 38) may be rounded and arranged to guide the grapple 50 of a lifting device as the grapple is extended and retracted in the z-direction. The grapple 50 has a guide 52 at each corner of the grapple. The guides 52 of grapple 50 define a rounded edge having a contoured outer surface that is complimentary to the corners of corner section 38. As shown in FIG. 2B, grapple 50 has a surface area that is slightly smaller than the cross-section of the shaft such that when the grapple is lowered into the shaft toward containers 10, each one of the four guides 52 is placed within a corner section 38 of a respective pillar such that the four pillars collectively prevent the grapple from unintentionally swaying in either the x-direction and/or in the y-direction. In this regard, the four pillars 16 defining the shaft act in concert to align grapple 50 to a stack 12 of containers 10 during a lifting operation. Specifically, the four pillars 16 act as a boundary that collectively limit lateral movement of grapple 50.

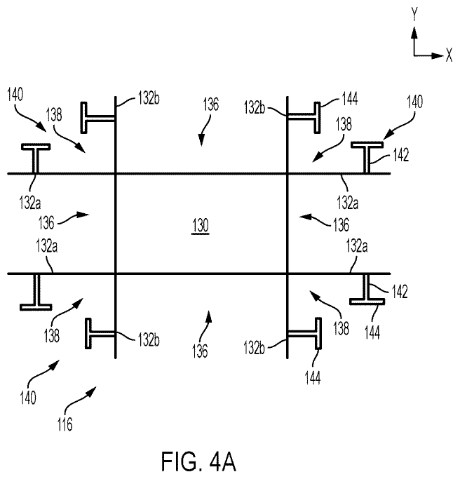

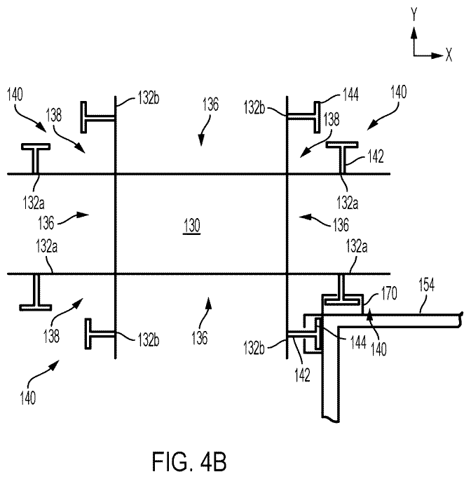

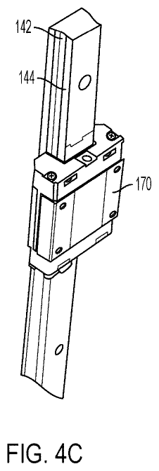

FIG. 4A is a schematic top elevation view illustrating a pillar 116 designed to replace the pillar 16 of grid-based storage frame 14 shown in FIG. 1. Pillar 116 includes all the features of pillar 16 and additional constraining features 140 arranged to prevent a grapple from swaying relative to the pillar during a lifting operation. With reference to FIGS. 4A-4C, the constraining features 140 of pillar 116 define a linear rail that guides a carriage 170 (e.g., a linear bearing/bushing) provided on grapple 154 along the pillar in the z-direction but prevents the grapple from swaying relative to the pillar in the x-direction and in the y-direction. Consequently, a single pillar 116 can align the grapple to a stack 12 of containers 10 as effectively, or more effectively, than four conventional pillars 16, thereby removing the need to support the other three corners of a grid space with a pillar. As a result, a grid-based storage frame utilizing pillars 116 to support grid 26 can be built with up to 75% less pillars than a grid-based storage frame utilizing conventional pillars 16.

Pillar 116 may be formed of a metal, such as aluminum, or a metal alloy, such as steel. The body of pillar 116 may have a cross section that is shaped generally as a number sign (#) defining a quadrilateral center section 130 and four pairs of parallel ribs extending away from a center axis of the center section. A first pair of parallel ribs 132a and a second pair of parallel ribs 132a extend from opposite sides of central section 130 in an x-direction to secure rails 22a, while a third pair of parallel ribs 132b and a fourth pair of parallel ribs 1326 project from opposite sides of the central section in a y-direction to support rails 22b. Pillar 116 may optionally include clips (not shown) disposed within side sections 136 of the pillar that are structurally and functionally similar to the clips 34 of pillar 16.

As shown in FIG. 4A, each constraining feature 140 is generally “T” shaped and disposed within a corner section 138 of pillar 116. Constraining features 140 define a linear track 142 and a protrusion 144 extending substantially parallel to rib 132a or rib 1326 from which the constraining feature is connected. The linear track 142 of constraining feature 140 guides the carriage and, in turn, the grapple along pillar 116 (e.g., in the z-direction) while protrusions 144 prevent the grapple from moving away from the pillar. Constraining features 140 may include a tapered lead in feature located at the top of pillar 116 to guide the carriage 170 of grapple 154 into alignment with the linear track 142 of the constraining feature. A tapered lead in feature could additionally, or alternatively, be provided on the carriage 170 of grapple 154.

Although it is not necessary for each corner section 138 of pillar 116 to include a constraining feature 140, when one or more constraining features are disposed within each corner section, a single pillar 116 can constrain the carriage 170 of grapple 154 when the grapple is positioned within any four shafts adjoining that pillar. As a result, each of the other three corners of the four adjoining grid spaces need not include a pillar, and frame 14 can be constructed using a minimum number of pillars. It will be appreciated that carriage 170 may be added to any known grapple such as grapple 50, schematically illustrating the grapple disclosed in U.S. Pat. No. 9,656,802, or the grapple of 154 of robot 100, illustrated in FIGS. 3A and 3B.

FIG. 3A illustrates a robot 100 equipped with grapple 154 according to an embodiment of the present disclosure. Each robot 100 is designed to be installed on the grid 26 of frame 14 and has a communication interface for sending and receiving data between the robot and one or more remote processors enabling the remote processors to coordinate movement and operation of the entire fleet of robots installed on the grid. Robot 100 includes a vehicle body 102 and a wheel assembly 104 configured to guide movement of the vehicle body about rails 22 to a location above a desired stack 12 of containers 10. Wheel assembly 104 may include a plurality of wheels, a motor, and one or more transmissions (belts or linkages) operably coupling each one of the wheels to the motor. The orientation of the wheels is controlled by the motor and the one or more transmissions. More specifically, the motor is coupled to each one of the wheels, via the one or more transmissions, such that rotation of the motor simultaneously pivots the orientation of each one of the wheels. In this regard, the wheels may simultaneously pivot between a first orientation in which each one of the wheels is aligned with the first set of parallel rails 22a and a second orientation in which each one of the wheels is aligned with the second set of parallel rails 22b. A drive mechanism is associated with wheel assembly 104 to propel the wheels and move vehicle body 102 along the rails in which the wheels are positioned.

Robot 100 may also include a picking arm 106 equipped with an end effector 108 for picking and packing inventory and one or more grapples 154 for lifting containers 10 from a desired stack 12. As shown in FIG. 3A, robot 100 includes two grapples 154: a first grapple attached to a front of vehicle body 102 and a second grapple attached to a back of the vehicle body. However, it is contemplated that robot 100 may include one, two, three or four grapples 154 and that the grapples may be attached to the sides of vehicle body 102 in any arrangement.

Each grapple 154 is suspended from support arms 152 by cables 156 which are connected to a winding mechanism 158 such as a spool, hoist, or winch. The cables 156 can thus be wound and unwound to adjust the height of grapple 154 with respect to support arms 152 in the z-direction to lift one more containers 10 to a location above grid 26.

With additional reference to FIG. 3B, grapple 154 includes a three-sided grapple plate 160 and pivotable flaps 162. The three sides of grapple plate 160 are formed by opposing grapple arms 164 and a connector 166. Grapple arms 164 and connector 166 collectively defining an aperture. Each flap 162 is pivotable relative to a respective grapple arm 164 between a deployed configuration in which the flap extends away from the grapple arm and into the aperture, and an undeployed (retracted) configuration in which the flap lies substantially flush against the grapple arm. Movement of flaps 162 between the undeployed and deployed configurations may be controlled by an actuator 163 disposed within grapple 154 configured to convert an electrical signal carried through cables 156 to rotational motion of the flaps. When flaps 162 are in the undeployed configuration, the aperture is larger than a perimeter of containers 10 such that grapple 154 can be lowered into a small gap provided between pillars 116 and a stack 12 of the containers before the flaps are deployed and brought into engagement with a securement feature, such as a rib (not shown), on a side of the container. In this manner, grapple 154 is designed to lift the container 10 secured to the grapple and each of the containers stacked on top of that container in a single lift.

Each corner of grapple 154 includes a carriage 170 designed to cooperate with the constraining features 140 of pillar 116. With additional reference to FIGS. 4B and 4C, carriage 170 includes roller bearings, or a similar device, designed to roll, slide, or otherwise move along the linear track 142 of constraining feature 140 as grapple 154 is extended and retracted vertically within the shaft.

Use of grapple 154 to extract a container 10 from underneath grid 26 will now be described. Upon receiving instructions to retrieve a particular container 10, the wheels of wheel assembly 104 may be pivoted to navigate the vehicle body 102 of robot 100 about grid 26 and to position grapple 154 above the stack 12 of containers housing the desired container. Grapple 154 may then be lowered into the shaft to position the roller bearings of carriage 170 against the linear track 142 of constraining feature 140 and between protrusion 144 and the parallel rib from which the constraining features is connected. This alignment may be facilitated by the tapered lead in features. Once in this position, the carriage 170 of grapple 154 is constrained by the constraining feature 140, thereby preventing the grapple from moving away from pillar 116 in the x-direction and in the y-direction as the grapple is lowered in the z-direction.

After grapple 154 has been lowered around the desired container 10, flaps 162 may be deployed and brought into engagement with a rib on a side of the container to secure the container to the grapple. With container 10 secured to grapple 154, the winding mechanism 158 may be wound to retract grapple 154 and to lift the container and, if applicable, any containers stacked thereon.

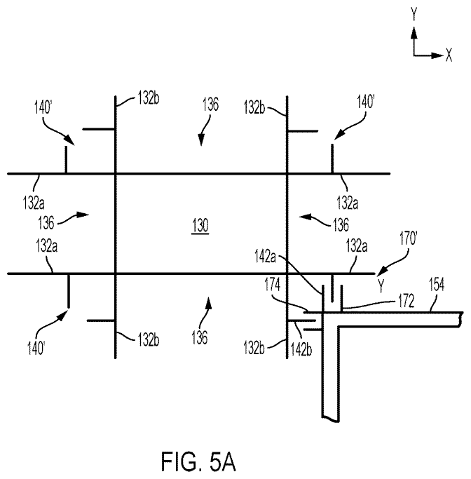

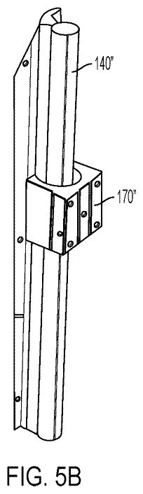

It will be understood that the constraining features need not be “T” shaped and other shapes may be utilized so long as the constraining features define a linear track that guide movement of the carriage 170 of grapple 154 in the z-direction and prevent the grapple from swaying away from pillar 116 in the x-direction and the y-direction. For example, FIG. 5A illustrates a pillar 116 having variant constraining features 140′ designed to cooperate with a grapple 154 having a variant carriage 170′. Each of the variant constraining features 140′ includes a first protrusion 142a and a second protrusions 142b. The first protrusion 142a of variant constraining feature 140′ extends away from the first and second pairs of parallel ribs 132a in the y-direction and into a respective one of the four corner sections 138 of pillar 116. The second protrusion 142b of variant constraining feature 140′ extends away from the third and fourth pairs of parallel ribs 132b in the x-direction and into the same corner section 138 as its counterpart first protrusion 142a such that a small gap is formed between the first and second protrusions of a respective constraining feature.

With continued reference to FIG. 5A, variant carriage 170′ includes one or more first guides 172 projecting in a y-direction and one or more second guides 174 projecting in the x-direction. A roller bearing, or similar device, is attached to the first guide 172 and the second guide 174 of variant carriage 170′ to allow the variant carriage to move along the linear track of variant constraining feature 140′ in the z-direction.

In use, the variant constraining features 140′ of pillar 116 constrain the variant carriage 170′ of grapple 154 and prevent the grapple from moving away from a central axis of the pillar in both the x-direction and in the y-direction. When grapple 154 is extended in the z-direction, the roller bearings of first guide 172a are positioned on opposite sides of first protrusion 142a and the roller bearings of the second guide 174′ are positioned on the opposite sides of second protrusion 142b. Consequently, engagement between the first guide 172 and first protrusion 142a prevents grapple 154 from swaying in the x-direction and engagement between the second guide 174 and second protrusion 1426 prevents the grapple from moving away from the pillar 116 in the y-direction while the roller bearings permit the grapple to slide along the linear track defined by the variant constraining features 140′ of pillar 116 in the z-direction. As a result, grapple 154 is constrained to pillar 116 and aligned with the stack 12 of containers 10.

FIG. 5B illustrates yet another variant constraining feature 140″. As shown in FIG. 5B, variant constraining feature has a circular or oval cross-section designed to cooperate with a correspondingly shaped variant carriage 170″. It will be appreciated that variant constraining feature 140″ will guide the variant carriage 170″ of grapple 154 along pillar 116 in the z-direction and prevent the grapple from translating away from pillar 116 in the x-direction and in the y-direction. While FIGS. 4A-4C, 5A and 5B illustrate example constraining features, the constraining features may be formed to have any structure that prevents grapple 154 from moving relative to pillar 116 in the x-direction and the y-direction as the grapple is lowered along the pillar in the z-direction.

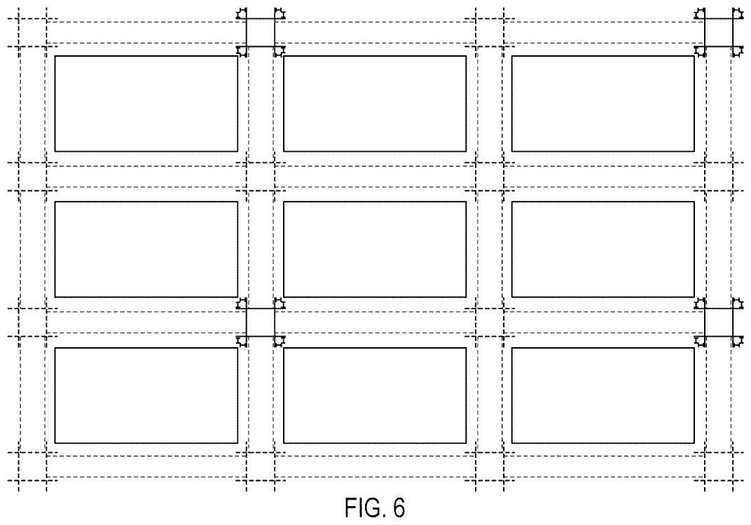

FIG. 6 is a schematic top elevation view of a portion of frame 14 constructed using grid pillars 116. As shown in FIG. 6, frame 14 only includes a single pillar 116 at the center of four adjoining grid spaces. Put differently, the other three corners of the four adjoining grid spaces do not include a pillar (the absence of which is illustrated in FIG. 6 using dashed line). Thus, when constraining features 140 of pillar 116 are disposed within each corner section 138, the pillar is configured to constrain grapple 154 to the pillar, irrespective of which of the four shafts the grapple is located. In this regard, frame 14 can be constructed using less pillars and for significantly less money than a frame constructed from conventional pillars 16.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A pillar having a central axis extending in a z-direction for supporting a grid formed of a first set of a parallel rails extending in an x-direction and a second set of parallel rails extending in a y-direction, the pillar comprising at least one constraining feature arranged to prevent a grapple configured to extract a container located beneath the grid from moving relative to the pillar in the x-direction and in the y-direction as the grapple is lowered in the z-direction.

2. The pillar of claim 1, wherein the pillar includes a body and the at least one constraining feature is provided at a corner section of the body.

3. The pillar of claim 2, wherein the at least one constraining feature includes a plurality of constraining features, and wherein each one of the plurality of constraining features is provided at a respective corner section of the body.

4. A storage and retrieval system, comprising:
a storage structure including pillars extending in a z-direction, the pillars supporting a grid formed of a first set of a parallel rails extending in an x-direction and a second set of parallel rails extending in a y-direction, the grid defining a plurality of grid spaces; and
a plurality of containers being stackable upon one another to form a plurality of vertical stacks, each vertical stack being arranged within a footprint of a respective one of the plurality of grid spaces,
wherein each pillar includes at least one constraining feature arranged to prevent a grapple configured to extract a container located beneath the grid from moving relative to the pillar in the x-direction and in the y-direction as the grapple is lowered in the z-direction.

5. The system of claim 4, wherein the pillars comprise a metal or metal alloy.

6. The system of claim 4, wherein each grid space is supported by a maximum of three pillars.

7. The system of claim 4, wherein each grid space is supported by a maximum of two pillars.

8. The system of claim 4, wherein each grid space is supported by a single pillar.

9. The system of claim 4, wherein the at least one constraining feature is located at a corner section of a respective one of the pillars.

10. The system of claim 9, wherein the at least one constraining feature includes a plurality of constraining features and each one of the plurality of constraining features is provided within a respective one of the corner sections.

11. The system of claim 4, wherein each one of the pillars includes a body having a central section, first and second pairs of parallel ribs extending from opposite sides of the central section in the x-direction and third and fourth pairs of parallel ribs extending from opposite sides of the central section in the y-direction such that the first, second, third, and fourth pairs of parallel ribs define four corner sections, and wherein each one of the four corner sections includes one or more of the at least one constraining features.

12. The system of claim 11, wherein each one of the constraining features includes a first protrusion extending away from the first and second pairs of parallel ribs in the y-direction and into a respective one of the four corner sections.

13. The system of claim 12, wherein each one of the constraining features includes a second rib protruding away from the third and fourth pairs of parallel ribs in the x-direction and into a respective one of the four corner sections.

14. The system of claim 4, wherein the at least one constraining feature has a cross-section shaped approximately as a “T”.

15. The system of claim 14, wherein each corner section of a respective one of the pillars includes two of the “T” shaped constraining features.

16. The system of claim 4, wherein the at least one constraining feature has a circular or oval cross-section.

17. The system of claim 4, further comprising at least one robot installed on the grid, the robot including:
a body coupled to a wheel assembly, the wheel assembly including a plurality of wheels and a drive mechanism arranged to move the body along the first set of parallel rails and along the second set of parallel rails; and
at least one grapple extendable in the z-direction and arranged to selectively secure and lift one or more containers from a stack of containers, the grapple including at least one carriage provided at a corner of the grapple to engage the constraining feature of the pillar and to prevent the grapple from moving relative to the pillar in the x-direction and in the y-direction as the grapple is lowered in the z-direction.

18. The system of claim 17, wherein the at least one carriage includes roller bearings.

19. The system of claim 18, wherein the at least one carriage comprises a first carriage protruding from the corner of the grapple in the x-direction and a second carriage protruding from the corner of the grapple in the y-direction.

20. The system of claim 17, wherein the at least one carriage includes roller bearings on either side of a recess sized and configured to receive the at least one constraining feature.
